(19) United States
(12) Patent Application Publication
(10) Pub. No.: US 2004/0015450 A1
(43) Pub. Date: Jan. 22, 2004

(54) Biometric system and method for detecting duress transactions

(76) Inventors: Joseph Zingher, Beach Park, IL (US); Abraham Zingher, Beach Park, IL (US)

Correspondence Address: Edward K. Runyan, McDonnell Boehnen Hulbert & Berghoff, 32nd Floor, 300 S. Wacker Drive, Chicago, IL, 60606, US

(21) Appl. No.: 10/611,711

(22) Filed: Jul. 1, 2003

Related U.S. Application Data
(63) Continuation of application No. 09/927,033, filed on Sep. 24, 2001, now abandoned.
(60) Provisional application No. 60/237,584, filed on Oct. 3, 2000.

(51) Int. Cl. G06F 17/60

(52) U.S. Cl. 705/64

(57) ABSTRACT

A system for responding to a duress identification made at a biometric identification site. The system may include a processor, a memory, a biometric reader for collecting biometric information about a user, wherein the biometric information is used for determining if the user is an authorized user of the system. The system may also include a set of instructions stored in the memory, the set of instructions executable by the processor to determine whether the biometric information represents a normal identification or a duress identification; if the biometric information represents a duress identification, the system may initiate an emergency response, such as (for example) triggering a silent alarm.

### RELATED APPLICATION

The inventors claim priority to U.S. Provisional Patent Application No. 60/237,584, entitled “Biometric System And Method For Detecting Duress Transactions at Automated Teller Machines,” filed on Oct. 3, 2000, the entirety of which is expressly incorporated by reference.

### BACKGROUND OF THE INVENTION

1. Field of the Invention

The present invention relates to automated teller machines (ATMs) and more particularly to a method and system for detecting transactions made under duress at ATMs using biometric measurements.

2. Description of Related Art

With the advent of the automatic teller machine (ATM), it has become possible for banking withdrawals to be made without the assistance of human bank personnel or agents. For example, a customer may use an ATM to make deposits or withdrawals from a checking or savings account, or to determine the balance of such an account. Point-of-sale systems, where users may have purchases of, e.g., gasoline, groceries, or airline tickets, etc., directly debited from their bank accounts, use technology that is similar to that of ATMs.

Traditional ATMs identify a customer based on an identification card provided by the customer's bank (or financial institution) and a personal identification number (PIN) that is recorded in a database and, presumably, known only to the customer. When using a traditional ATM, the customer inserts an identification card into a slot of an ATM. The card includes a magnetic strip on which information about the customer's accounts (e.g., the numbers of the customer's accounts) is stored. The ATM responds to insertion of the card by prompting the customer to enter the customer's PIN. The ATM then compares the PIN entered by the customer to the PIN stored in the database. If the two PINs match, the ATM determines that the customer is authorized to access the account associated with the inserted card.

### SUMMARY OF THE INVENTION

It is now possible that the use of identification cards and even PINs to access ATMs or point-of-sale systems can be eliminated, and further, transactions made more secure, through the use of biometric identification (BID). See, for instance, U.S. Pat. No. 6,045,039. Biometrics is the study of using human physical traits to verify identity. Many human traits can be used to make biometric identifications, such as: fingerprints, recognition of retinal or iris scans, palm prints, DNA traces, voiceprints, and the speed, pressure, and motion associated with a physical act such as pressing keys or writing. See, for instance, U.S. Pat. Nos. 6,097,035, 6,045,039, and 5,613,012.

In addition to eliminating the use of identification cards and PINs to access ATMs, biometric identification methods and devices can also be used to generate or verify electronic signatures to validate paperless transactions (i.e., e-commerce or internet transactions). Electronic signatures are commonly defined as any type of sound, symbol or process that is attached to and logically linked to a document to identify the author or source of the document. Any of the biometric traits described above may be used in the process of creating or verifying an electronic signature.

While biometric identification is very useful in preventing fraudulent transactions, it does not solve the security problem posed by ATMs, specifically, extortion. The usual form of extortion at ATMs is to intimidate the ATM user by threat of physical harm. There are methods currently available to safeguard ATMs, most having to do with entering special codes on the keypad normally used for entering personal identification numbers or placing a panic button on an ATM. These methods, however, are not well suited to use in ATMs that use BID, as any act on the part of the user other than selecting a transaction and entering a transaction amount could alert the criminal that his crime has been reported, which in turn could result in harm to the user.

Accordingly, there is a need for the discreet identification of a duress transaction and the discreet notification of authorities that a crime is being committed at an ATM where biometrics are used to confirm the identity of a user.

The present system and method provides for discreetly identifying and signaling a user's duress at an automatic teller machine or other biometric identification site (e.g., a building checkpoint or an automobile) through the use of a biometric identifier-emergency (BIDE). The BIDE is used by an ATM customer to signal both banking and law enforcement authorities that the user is under duress, and to send help without alerting the criminal that the user is calling for help. In the system, BID functions normally.

BIDE, on the other hand, functions as an alternate biometric identifier which also has a set of instructions to initiate an alarm to notify the police or an emergency operator as is well known in the industry—for example, a silent bank robbery alarm. To trigger a BIDE response, an ATM user could employ an alternate biometric identifier that is nearly indistinguishable from a non-emergency identifier. Furthermore, the prompts displayed by the ATM or other computerized system accepting a BIDE could be made indistinguishable from those displayed by an ATM or computerized system accepting a normal BID transaction.

The system and method disclosed provides a safe and efficient way to make all ATMs that use biometric identification methods the equivalent of a “911” emergency line. The system provides a simple, certain, and secure way of allowing a customer to alert the police that a crime is taking place without alerting a criminal that an alarm has been given. BIDE use could trigger a silent alarm connected to the nearest police station, initiating a police response.

In an exemplary embodiment of the present invention, an ATM user can provide an alternate biometric identifier (BIDE) to an ATM, allowing it to identify a transaction as a duress transaction. For example, in fingerprint biometric identification, a customer might submit one finger to be examined and analyzed at an ATM in order to conduct an ordinary transaction. Once the customer's identification is verified, using the biometric information, the transaction proceeds normally. However, by using a different finger, the ATM may also make a positive identification of a customer and instruct the system to trigger an alarm sequence without alerting a criminal that the transaction has been identified as a duress transaction. Similarly, where the biometric identification is by retinal or iris scan, a customer could simply use his or her other eye (i.e., whichever eye does not correspond to a normal transaction) as the BIDE trigger. Alternatively, a BIDE could be triggered by other means, such as rapid successive blinking of one or both eyes, tapping a fingerprint scanner, pressing hard on the lens of a fingerprint scanner, or pressing the forehead, for example, against the headrest or similar structure associated with a retinal scanner.

Where biometric identification is made by sensing the speed, pressure, or pattern of a user's signature or other writing, a BIDE may be made when the user alters any of the measured variables: for example, the user might change the shape of a letter, cross a “T” twice, make an extraneous mark when making the writing, etc.

In an alternative exemplary embodiment or as an additional feature of any embodiment described herein, a method and/or system which identifies a duress transaction at an ATM may discreetly notify the police or other agency.

In addition, the system, having identified a duress transaction at an ATM, may; discretely notify the police while slowing down a transaction, giving police more time to respond; limit the funds available from a customer's account so that a criminal cannot get away with large sums of money; dispense marked bills to assist in positive identification of the criminal; or reject a transaction with an “unable to complete transaction” message and then slow down the transaction on any subsequent attempts. Further, an entire ATM system could be alerted citywide or nationwide to the fact that a forced transaction has occurred. If a criminal makes it away from the first location and attempts to force another withdrawal, the system could alert the police that another transaction was attempted. Still further, along with the alarm, the system could give a general description of the customer for the police to use, thus avoiding a potential tragedy because of mistaken identity, as well as giving the police an extra edge in spotting the parties involved.

In another exemplary embodiment, an individual can provide a BIDE to a biometric identification site, such as a building security checkpoint or the entrance/ignition system of an automobile. Once a BIDE is triggered in such an embodiment, the system can function similarly to the ATM embodiment.

Specifically, a silent alarm could alert the police or other appropriate agency that a user was under duress during the identification. Further, the actions allowed by the system could be made to appear normal while at the same time giving the police more time to respond to an emergency. For example, the system could delay entry into a building protected by a biometric identification system, or bar entry altogether while displaying a message that indicates the reason for the delay was not due to any action taken by the system's user. For example, the system could display a message indicating that the user's identification could not be confirmed (although it actually had been confirmed), while at the same time triggering a silent alarm.

Where the system is used for entry into or to enable the ignition system of an automobile, a BIDE could, in addition to sending a silent alarm to the police, cause the automobile to operate in an impaired manner to give police more time to respond to the emergency.

In another exemplary embodiment, a user can provide a BIDE rather than a BID while the user is providing a biometric identification to verify or generate an electronic signature for a paperless or internet or e-commerce transaction. Once a BIDE is triggered in such an embodiment, the system would function similarly to the ATM embodiment.

These, as well as other advantages of the present invention will become apparent to those of ordinary skill in the art by reading the following detailed description with appropriate reference to the accompanying drawings.

### BRIEF DESCRIPTION OF THE DRAWINGS

A fuller understanding of the foregoing may be had by reference to the accompanying drawings wherein:

FIG. 1 is a simplified block diagram of an automatic teller machine having a biometric reader;

FIG. 2 is a simplified schematic view of an exemplary embodiment of the present system;

FIG. 3 is a schematic view of an alternate embodiment of the present system;

FIG. 4 is an alternate schematic view of the system shown in FIG. 2;

FIG. 5 is a flow chart of an exemplary embodiment of a method of identifying a duress transaction;

FIG. 6 is an expanded flow chart of the method illustrated in FIG. 5;

FIG. 7 is an alternate expanded flow chart of the illustration in FIG. 5;

FIG. 8 is a front view of an automatic teller machine for use with the present invention;

FIG. 9 is a front view of an alternate automatic teller machine for use with the present invention; and

FIG. 10 is a flow chart of another alternate embodiment of the present invention wherein the PIN/BIDE must be entered before receiving funds.

### DETAILED DESCRIPTION OF AN EXEMPLARY EMBODIMENT OF THE PRESENT INVENTION

While the invention is susceptible of embodiment in many different forms, there is shown in the drawings and will be described herein in detail, an exemplary embodiment and alternate exemplary embodiments of the invention. It should be understood, however, that the present disclosure is to be considered an exemplification of the principles of the invention and is not intended to limit the spirit and scope of the invention and/or claims of any embodiment illustrated.

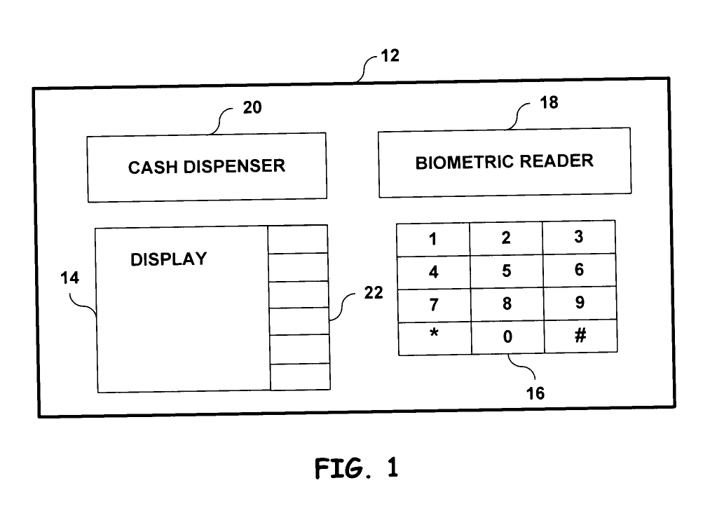

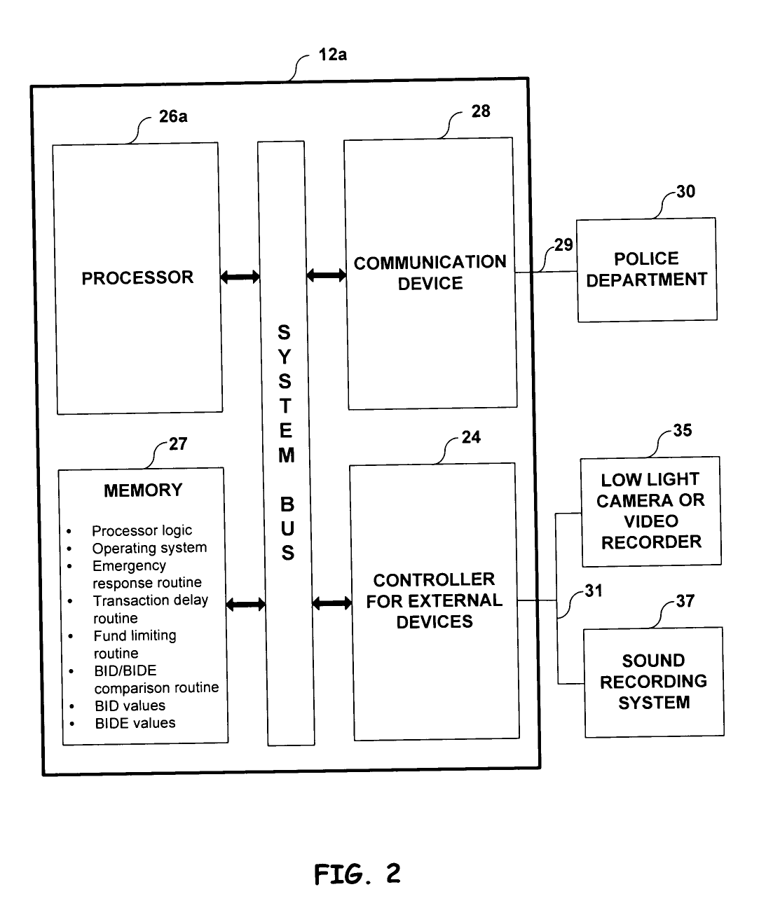

FIGS. 1 through 10 illustrate a system and method of the present invention, as well as alternate embodiments, for use with an ATM 12, such as that illustrated in FIG. 1, having a display 14, a keypad 16, a biometric reader 18, and a cash dispenser 20. The biometric reader 18 can include such components as, for example, lenses, lens covers and hoods, scanners, headrests (for retinal scanners), etc., in addition to routines stored in a memory to execute biometric identifications. Function buttons 22 are illustrated next to display 14. ATM 12 may further include a processor or computer for detecting a biometric value stored in a bank's computer system (See FIG. 2).

During an ATM transaction, an ATM “recognizes” a customer based on the customer's biometric value. Let the stored biometric information for a customer's left eye, for example, represent a particular customer. During the recognition phase of entering a biometric identification (BID), the ATM computer recognizes “left eye, account holder Smith” as the correct BID. When an incorrect BID is read by the system, the ATM computer recognizes, for example, “eye, pattern not recognized” as incorrect and rejects the BID. The exemplary embodiment is generally illustrated by the addition of another step during the recognition process.

For example, if a user under duress purposely submits his right eye for recognition, the computer can be programmed to recognize that Smith's right eye was read by the system—i.e., that a biometric identification—emergency (BIDE) was entered. Rather than reject the BID as invalid, the ATM computer could then cause the system to notify the nearest police station that the person withdrawing the cash is under duress. Notification of the authorities can be accomplished through the use of a telephone dialer with a pre-recorded message or a “silent” alarm, similar to a jewelry store's or a bank's burglar alarm. Police could then have “real-time” notice that a crime is in progress. Further, an ATM 12 of the exemplary embodiment may incorporate various devices to prevent criminals from detecting what biometric represents a BID vs. a BIDE. For example, an ATM 12 may incorporate a shield or hood, etc., over a fingerprint scanner or an eye scanner, making it impossible for an eavesdropper to see which eye, finger, etc., a user submitted for a BID.

FIGS. 2-4 illustrate an ATM duress system of the exemplary embodiment. Such an ATM can take two different forms. The ATM could have its own separate processor, or it could be directly linked to a bank's processor.

FIG. 2 illustrates ATM 12a that may have its own processor 26a (e.g., an integrated circuit microprocessor), a memory 27 (e.g., ROM, flash memory, hard disk, etc.), a controller 24 for controlling the external devices of the ATM, and a communication device 28 such as a telephone dialer with a prerecorded message, all of which may be interconnected by a system bus. Memory 27 may include more than one physical element, and may also include: an operating system for processor 26a; an emergency response routine (i.e., a set of instructions executable by a processor, typically stored in memory); a BID/BIDE comparison routine, a fund limiting routine; a transaction delay routine, and; BID and BIDE values. This particular configuration is not crucial to the functioning of the present invention. For example, the system could be implemented by a device without a system bus and having a memory and processor contained in one integrated circuit. Further, those skilled in the art will appreciate that many of the elements described in this exemplary embodiment are functional entities that may be implemented as discrete components or in conjunction with other components, in any suitable combination and location.

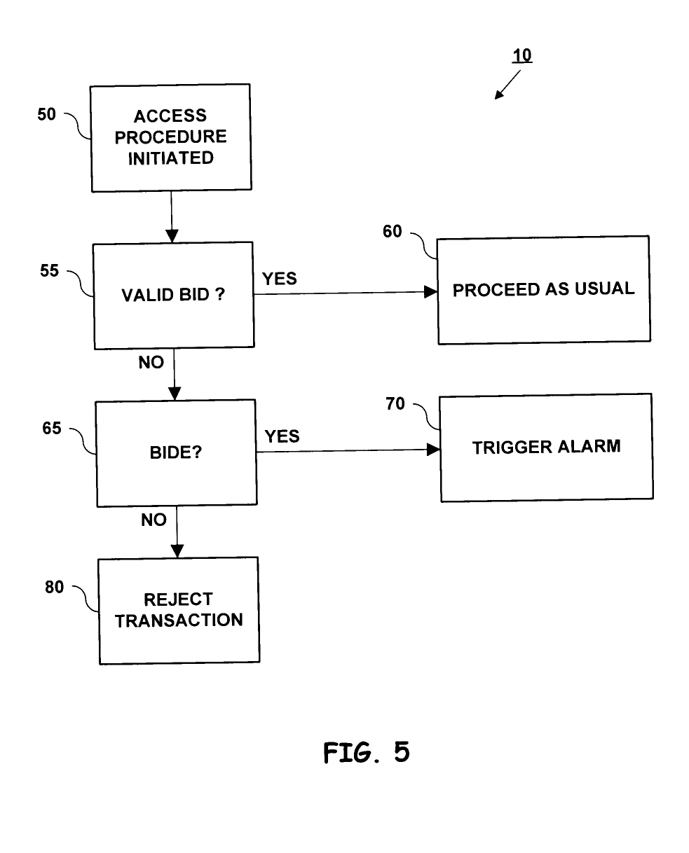

The ATM processor 26a can perform the BID or the BIDE validation process, which will be described in more detail with reference to FIGS. 5-7.

Upon determination that a BIDE has been recognized, the processor 26a can cause the communication device 28 to contact the appropriate authorities. For example, a telecommunication dialer, via a data link 29 (phone line, etc.) can contact the police department dispatch center's telephone or computer system 30, thereby discreetly informing the police that a duress transaction is occurring. Communication device 28 can send a prerecorded message to the police indicating the location of the duress transaction and the name of the individual under duress. Alternatively, the ATM computer or bank central processing computer could send a piece of information commonly referred to as an “identifier”. Identifiers are commonly used by police to access information about individuals through various databases, such as the National Crime Information Center (NCIC) or a state's Department of Motor Vehicles database. Common identifiers include: social security numbers, driver's license numbers, full name and date of birth, passport numbers, etc.

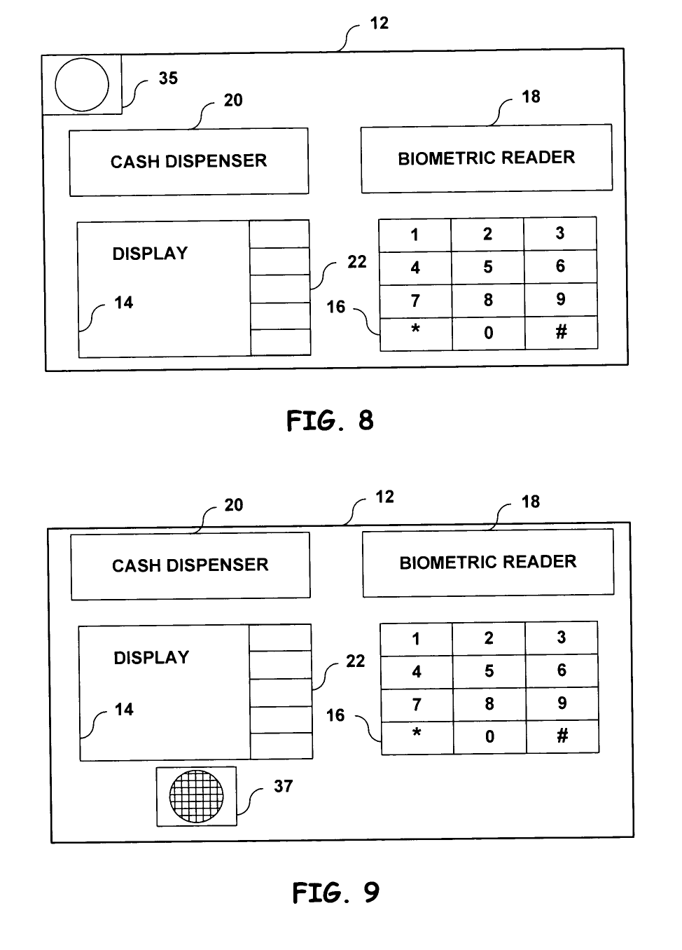

By use of a physical description of an authorized user (e.g., an identified customer) stored either at the ATM or the bank's processor, the ATM computer could also send a description of the customer to the police, thus assisting in the identification of the customer and thereby the robber. Further, ATM 12a may be connected via a data link 31 to a low light camera or videorecorder 35 or sound recording system 37, which will be described in more detail in reference to FIGS. 8 and 9.

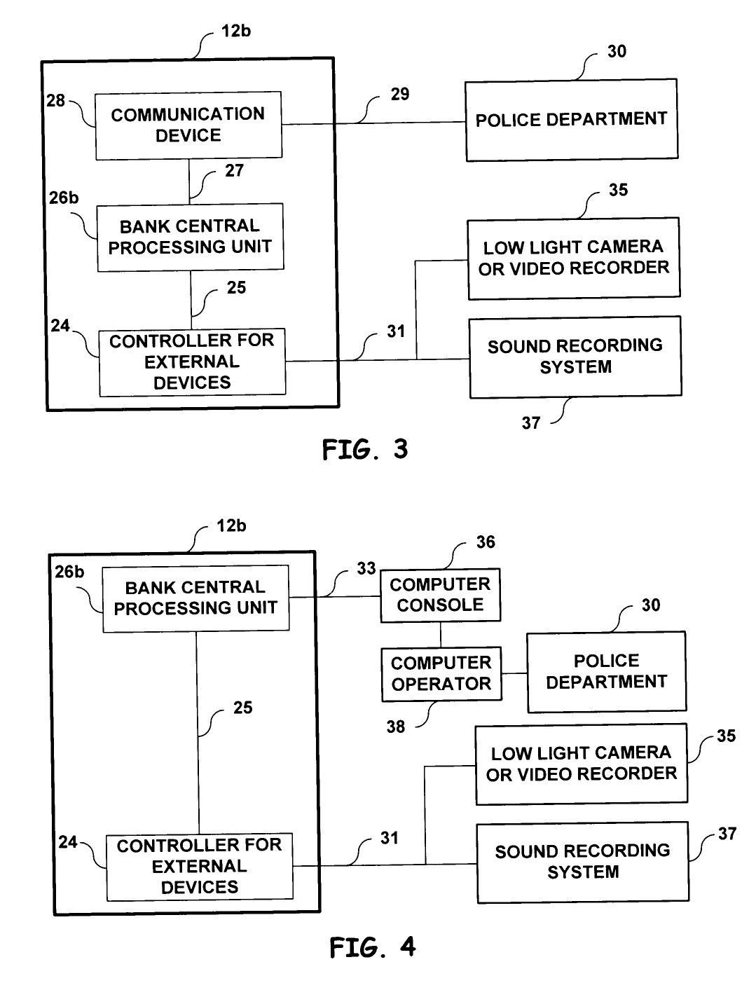

FIG. 3 illustrates ATM 12b being connected directly to a bank's processor 26b. ATM 12b further includes a controller 24 for controlling the external devices of the ATM, and a communication device 28 such as a telephone dialer with a prerecorded message. The controller 24 may be communicatively coupled to the processor 26b via a data link 25. The bank's processor 26b can perform the BIDE validation process, which will be described in more detail with reference to FIGS. 5-8 and 11.

Upon determination that a BIDE has been recognized, the processor 26b, via a data link 27, may inform the communication device 28 to contact the appropriate authorities. For example, a telecommunication dialer, via a data link 29 (phone line, etc.) could contact the police department's dispatch center's telephone or computer system 30, thereby discreetly informing the police that a duress transaction is occurring. Communication device 28 can send a pre-recorded message to the police indicating the location of the duress transaction and the name of the individual under duress. Further, ATM 12b may be connected via a data link 31 to a low light camera or videorecorder 35 or sound recording system 37, which will be described in more detail in reference to FIGS. 8 and 9.

FIG. 4 illustrates an alternate embodiment of a system wherein ATM 12b is connected directly to the bank's processor 26b. ATM 12b further includes a controller 24 for controlling the external devices of the ATM. The controller 24 may be communicatively coupled to the processor 26b via a data link 31. The bank's processor 26b performs the BIDE validation process, which will be described in more detail with reference to FIGS. 5-7.

Upon determination that a BIDE has been recognized, the processor 26b, via a data link 33, may send an alarm signal with the appropriate information, via data link 33, to a computer console 36 at a remote location. A computer operator 38 monitoring the computer console 36 could then notify or contact the appropriate authorities, such as police department 30. Further, ATM 12b may be connected via a data link 31 to an event recorder such as a low light camera, a videorecorder 35, or sound recording system 37, which will be described in more detail in reference to FIGS. 8 and 9.

Referring now to FIG. 5, the general BIDE method of the exemplary embodiment 10 is illustrated. This method is accomplished by adding to the Customer's Information File in the ATM system, an additional “duress BID” or BIDE. (A Customer's Information File is the file which keeps the information relevant to an individual customer's accounts at the bank where the customer does business.)

The BIDE process, such as using an alternate eye, palm, or finger, or an action taken in combination with a BID, may be chosen by a customer, so that it can be easily remembered by the customer and not confused by the customer with that customer's regular BID procedure. Thus, if the customer's regular BID procedure is to use the left eye, the BIDE procedure could be to use the customer's right eye. Further, the BID and BIDE need not even be of the same biometric type. For example, a BID may be the left eye, while the corresponding BIDE may be the right index finger. Other biometric combinations, such as voice recognition BID and body measurement BIDE, may also be used. Further, with a retinal scanner as a biometric reader, a BIDE could be made by a user's rapidly blinking his eyes (or blinking his eyes in another unusual manner) while submitting an otherwise normal BID. With such an embodiment, storing a BIDE could be simpler because the BIDE could consist of BIDs already recorded for users with the addition of a routine stored in memory 27 for adding one or more blinking patterns. In other words, a BIDE could be represented by a normal BID in combination with an eye-blinking pattern that is either selected by a user or by the user's bank or financial institution.

As another alternative, a user could trigger a BIDE by actuating a pressure-sensitive switch or other sensor that is incorporated into the normal BID reader. For example, the user could exert pressure on a lens of a fingerprint scanner or a headrest or other structure associated with a retinal scanner. Such an activation could be made to be undetectable to anyone but the user submitting a BID or BIDE. As used here, the tern “pressure-sensitive switch” is intended to be a basic description only, and is not limited to a mechanical switch that depends on only motion or pressure to be actuated. For example, a pressure-sensitive switch in accordance with the present invention could include, in addition to a pressure sensor, a routine stored in memory 27 for recognizing a pattern of pressure such as a user pressing on the sensor a number of times within a fixed period of time. The pressure-sensitive switch could also include a routine stored in memory 27 for recognizing a change in a user's normal signature pressure pattern to trigger a BIDE.

A BIDE could also be triggered by pressing a concealed button, such as a button near a fingerprint scanner. Such a button could be concealed beneath a hood that also could serve to conceal which finger a user places on the fingerprint scanner.

In operation, a customer, after arriving at an ATM, may first initiate access to the system by submitting his or her eye, finger, etc. for recognition, generally indicated as step 50. A computer may then attempt to verify the BID at step 55. If the received biometric value is a customer's correct BID, the transaction could then proceed as usual, as shown at step 60.

Upon failure of the BID, the ATM computer may set a flag indicating a failed identification and attempt to verify the biometric value as the customer's BIDE, as shown at step 65. If the ATM computer verifies the scanned biometric value as the customer's BIDE and the access flag is set, then the computer may cause a signal to be sent to alert the authorities, as shown at step 70, and then continue processing the transaction. If the computer does not verify the customer's biometric value as either a BID or BIDE, then the ATM computer could continue with ordinary failed access procedures, as shown at step 80.

By storing a second biometric value as the BIDE of a customer, some problems associated with ATM security and alarms may be solved. For example, even with a gun in a customer's back, a criminal would not know whether a normal BID or a BIDE has been used. Once a BIDE has been verified, the system, using a silent alarm similar to a jewelry store's or a bank's burglar alarm, could immediately alert the nearest police station that a robbery was in progress, and police could be dispatched to the scene, providing a “real-time” response to the crime.

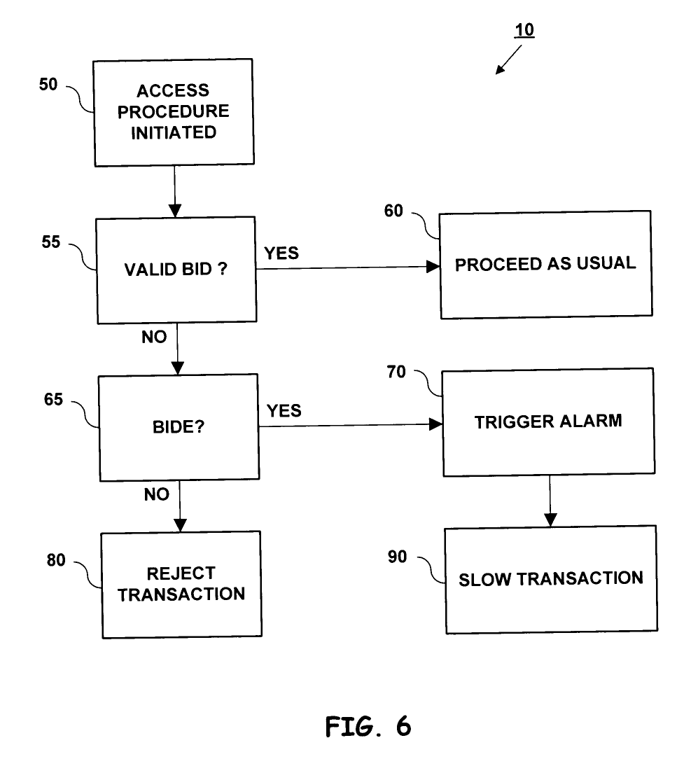

FIG. 6 illustrates an expanded flow chart of FIG. 5. After an access number has been entered, as shown at step 50, and a BIDE verified, as shown at step 65, the silent alarm or distress call could be triggered, as shown at step 70. The system can then cause various actions to occur.

For example, the whole transaction could be slowed down, as shown at step 90, i.e., the entire transaction process could be delayed such that the system takes longer to dispense cash. In this manner, the notified authorities could have more time to respond to the distress signal than they would ordinarily. The slowed transaction could take several forms. The system could at first refuse the request and give out a false “out of service” message or “Error—Please try again” message. The customer could be required to restart the transaction. The system could merely stall for time by slowing down the generation of user instruction screens and then giving a “Transaction in Progress” message. Ultimately, the system could dispense cash (that might be debited to the person's account or not, depending on the system's administrator), so that the robber does not become agitated and harm the user.

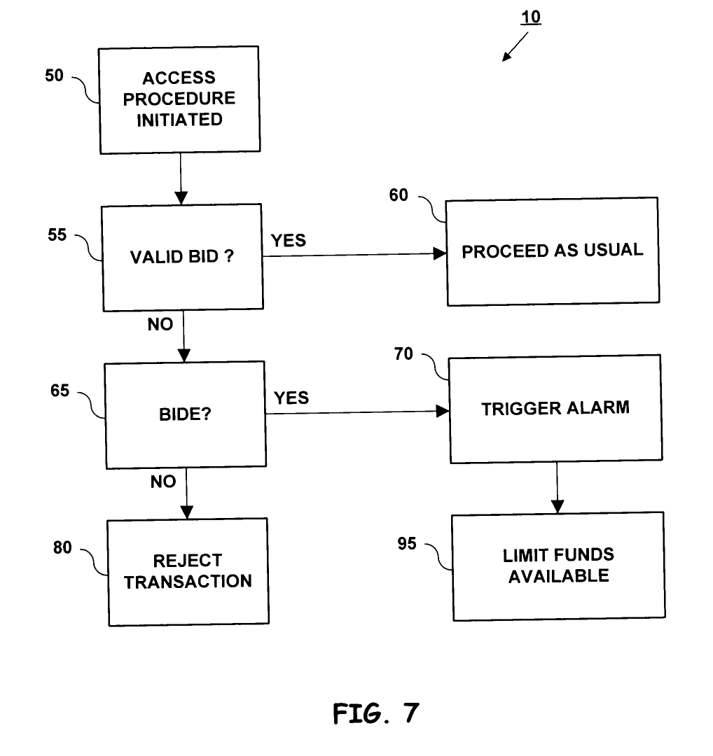

FIG. 7 illustrates another alternate expanded flow chart of FIG. 5. After an alarm has been triggered, as shown at step 70, the computer could automatically limit the funds available to be dispensed, as shown at step 95. If, for example, more than $50.00 is requested to be withdrawn, the system could provide a message stating, for example, “Your Request Exceeds the Maximum Allowable Withdrawal at this Machine”.

It should be understood that after the alarm has been triggered, the ATM system could perform one or more of the steps illustrated in FIGS. 6 and 7.

For example, a bank, financial institution, a building operator, or an automobile manufacturer, etc., could install an event recorder to record occurrences in proximity to a biometric reader. For example, the event recorder could record events occurring within a 4foot radius of the biometric reader. Of course, the proximity could be increased depending on factors such as the placement and sensitivity of the event recorder and the amount of memory available to store the recorded events. In the context of the event recorder, such memory could be digital memory such as memory 27, or it could be another medium such as a video cassette. FIG. 8 illustrates an ATM having a low-light level camera or videorecorder 35 to photograph or videotape the area immediately surrounding the ATM to record events. Camera 35 could be activated upon the identification of a BIDE. Similarly, FIG. 9 illustrates an ATM having a sound recording system 36 to record voices and sounds (e.g., digitally or on analog tape) for later identification and use. When a BIDE is verified, this sound recording system could be activated to record any sounds or voices, as an additional step to be performed after step 70.

In addition any event recorder described above could be recording information continuously. Such information could be stored temporarily for a relatively short period of time, such as 30 seconds, before being erased, in order to save memory resources. Then, if a BIDE is verified, the erasure of the previous 30 seconds could be prevented so that events that occurred prior to the BIDE could be recorded.

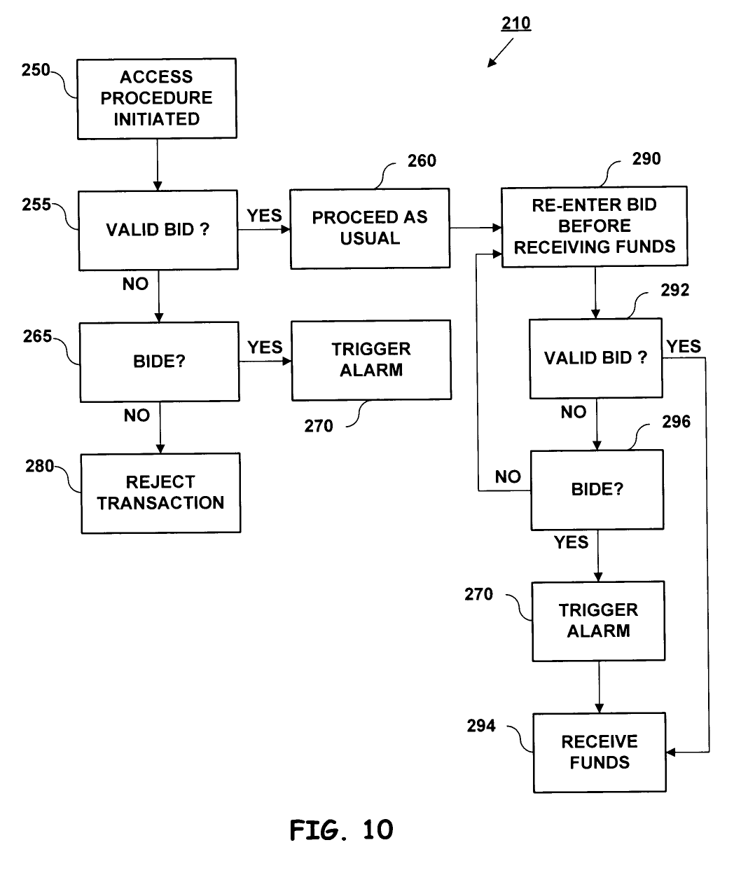

FIG. 10 illustrates another alternate embodiment which allows discreet identification and notification of a duress transaction that may arise during or in the midst of an ATM transaction, rather than before or at the start of the transaction. If a robber were to approach an ATM user after the ATM has verified a customer's BID, for example, that customer would have no way of notifying the police. Accordingly, the embodiment shown as 210 of FIG. 10 solves this problem by requiring all customers to re-enter their BID/BIDE just prior to receiving funds.

Accordingly, a user may approach an ATM and initiate a transaction by submitting a biometric to the ATM's biometric reader, as shown at step 250. The computer of the ATM may then attempt to verify the biometric as the customer's BID, as shown at step 255. If the customer's BID was not verified, the computer may attempt to verify the biometric as the customer's BIDE, as shown at step 265. If the customer's BIDE is verified, the communication device in the ATM could notify the appropriate authorities, as shown at step 270, and then proceed with the transaction. If neither the BID nor the BIDE have been verified, the ATM can reject the transaction, as shown at step 280.

If the ATM verified a valid BID, then the ATM transaction could proceed as usual, as shown at step 260. However, after a customer has entered the amount of cash to be received, the ATM computer could require the customer to re-verify the BID before receiving cash, as shown at step 290. Accordingly, should a criminal approach the customer after initially verifying the correct BID, or at step 260, the customer can still discreetly notify the authorities.

Upon being prompted to re-verify the BID at step 290, a customer has the option of submitting either the BID or the BIDE. When the customer submits a biometric, the computer may attempt to verify the biometric as the user's correct BID, as shown at step 292. If a valid BID has been recognized, the customer will receive the funds, as shown at step 294. If a valid BID has not been recognized, the computer may attempt to verify the biometric as the customer's BIDE, as shown at step 296. If the customer has entered the BIDE at step 290, the communication device of the ATM may notify the appropriate authorities, as shown at step 270. If neither the BID or BIDE have been verified at step 290, the ATM may provide an error message and prompt the customer to re-verify the BID. If the ATM cannot verify a biometric after a certain number of tries, three for example, the ATM could reject the transaction.

The embodiment shown at 210 provides a user with an additional chance to discreetly identify a duress transaction and notify the appropriate authorities. By requiring customers to re-verify their BIDs just prior to receiving funds, as shown at step 290, customers have two opportunities to discreetly notify the authorities of a duress transaction.

Further, the system and method of the exemplary embodiment could incorporate conventional card reading devices, to be used along with the ATM's biometric identification system. In this case, the user's card may be used to initiate the ATM transaction, then the biometric identification system may allow access to the system. After the user inserts the ATM card, the user might supply biometric information to the ATM, for example, by placing a finger on a scanning device. This biometric information could take the place of a PIN number.

The embodiments of the present invention disclosed herein have numerous benefits and advantages, as stated above. Furthermore, because an ATM customer can be immediately identified by the computer upon the triggering of the alarm, the police may learn who is in trouble, what that person looks like, what kind of car they drive, etc. The benefits to the police could mean, in some cases, the difference between life and death.

This idea has applications that go beyond simple ATMs. Virtually any situation where computer access to valuable property or information is regularly used could make use of this system. For example, keyless auto entry/ignition systems could incorporate a BIDE system; a car's cellular phone could be linked to a biometric entry/ignition system, whereupon detection of a BIDE by a processor in the car's entry/ignition system could cause a telephone dialer having a pre-recorded message to discreetly notify the police. The car's location could be provided by a number of available car tracking systems, such as GPS, Loran, or conventional radio tracking systems, as are well known.

Cardless building entry systems or security checkpoints could also incorporate exemplary biometric systems. For example, a building's security system could be linked to a biometric entry system, so that detection of a BIDE by a processor or computer of the building entry system or checkpoint could cause a telephone dialer having a pre-recorded message to discreetly notify the police of a duress entry.

It is to be understood that the embodiments herein described are merely illustrative of the principles of the present invention. Various modifications may be made by those skilled in the art without departing from the spirit or scope of the claims which follow.

We claim:

1. A system for responding to a duress identification made at a biometric identification site, the system comprising:
a processor;
a memory;
a biometric reader for collecting biometric information about a user, wherein the biometric information is used for determining if the user is an authorized user of the system; and
a set of instructions stored in the memory, the set of instructions executable by the processor to determine whether the biometric information represents a duress identification;
wherein the system initiates an emergency response if the biometric information represents a duress identification.

2. The system of claim 1, wherein the set of instructions further comprises a routine to determine whether the biometric information represents a normal identification.

3. The system of claim 1, further comprising:
an event recorder for recording occurrences in proximity to the identification site upon initiation of the emergency response.

4. The system of claim 3, wherein event recorder comprises a low-light camera.

5. The system of claim 3, wherein the event recorder comprises a microphone.

6. The system of claim 1 wherein the biometric information comprises an electronic signature.

7. The system of claim 1, wherein the emergency response includes triggering a silent alarm.

8. A system for responding to a duress transaction at a remote transaction terminal of an automated banking system, the remote transaction terminal having an input device, a cash dispenser for conducting transactions, and a biometric reader for receiving biometric information about a customer, the system comprising:
a memory;
a processor;
a comparison routine stored in the memory, the comparison routine executable by the processor to determine whether the biometric information represents a normal biometric identification or a biometric identification-emergency (BIDE); and
an emergency response routine stored in the memory, the emergency response routine executable by the processor to initiate an emergency response if the biometric information represents a BIDE.

9. The system of claim 8, further comprising:
a transaction delay routine stored in the memory, the transaction delay routine executable by the processor to delay a transaction upon initiation of an emergency response.

10. The system of claim 8, further comprising:
a cash limiting routine stored in the memory, the cash limiting routine executable by the processor to limit the cash delivered by the cash dispenser upon initiation of an emergency response.

11. A system for responding to a duress transaction at a remote transaction terminal of an automated banking system having a biometric reader and a cash dispenser, the system comprising:
a processor;
a memory;
a communication device;
at least one normal biometric identification (BID) value stored in the memory;
at least one biometric identification-emergency (BIDE) value stored in the memory;
a biometric comparison routine stored in the memory, the biometric comparison routine executable by the processor to determine whether biometric information read by the biometric reader represents a BID value stored in the memory or a BIDE value stored in the memory; and
an emergency response routine stored in the memory, the emergency response routine executable by the processor to initiate an emergency response if biometric information read by the biometric reader matches a BIDE value stored in the memory;
wherein the emergency response routine includes causing the communication device to contact an emergency operator.

12. A system for responding to a duress identification made at a biometric identification site, the system comprising:
a processor;
a memory;
a communication device; and
a biometric reader for collecting biometric information about a user, wherein the biometric information is used for determining if the user is an authorized user of the system;
wherein the biometric reader further includes a pressure-sensitive switch;
wherein a user under duress initiates an emergency response by activating the pressure-sensitive switch; and wherein
the processor causes the communication device to initiate a communication upon initiation of the emergency response.

13. The system of claim 12, further comprising:
an event recorder for recording occurrences in proximity to the identification site upon initiation of the emergency response.

14. The system of claim 13, wherein event recorder comprises a low-light camera.

15. The system of claim 13, wherein the event recorder comprises a microphone.

16. The system of claim 12, further comprising:
a transaction delay routine stored in the memory, the transaction delay routine executable by the processor to delay a transaction upon initiation of the emergency response.

17. The system of claim 12, further comprising:
a cash limiting routine stored in the memory, the cash limiting routine executable by the processor to limit the cash delivered by the cash dispenser upon initiation of the emergency response.

18. A method for responding to a duress identification at a remote transaction terminal of an automated banking system having a display, a biometric reader, a memory, a processor, and a cash dispenser, the method comprising:
storing at least one duress biometric identification value in the memory;
storing biometric information received at the biometric reader in the memory;
comparing the received biometric information with the at least one duress biometric identification value stored in the memory; and
initiating an emergency response if the received biometric information corresponds to the at least one duress biometric identification value stored in the memory.

19. The method of claim 18, further comprising:
storing at least one normal biometric identification value in the memory;
comparing the received biometric information with the at least one normal biometric identification value stored in the memory; and
initiating a normal transaction if the received biometric information corresponds to the at least one normal biometric identification value stored in the memory.

20. The method of claim 18, further comprising the step of:
initiating a transaction to dispense cash if an emergency response is initiated.

21. The method of claim 20, wherein the transaction to dispense cash is carried out in a manner identical to a transaction to dispense cash made if no duress biometric information is received.

22. The method of claim 18, further comprising the step of;
causing a communication device to make a communication if an emergency response is initiated.

23. The method of claim 15, further comprising the step of:
delaying the transaction time of the remote terminal if an emergency response is initiated.

24. The method of claim 15, further comprising the step of:
limiting the cash available to be dispensed by the cash dispenser if an emergency response is initiated.

25. The method of claim 18, further comprising the step of:
recording events in proximity to the remote transaction terminal if an emergency response is initiated.

26. A method for responding to a duress identification at an identification site having a biometric reader, a memory, and a processor, the method comprising:
storing received biometric information in the memory;
storing a normal biometric identification value in the memory;
storing a duress biometric identification value in the memory;
comparing the received biometric information with the normal and the duress biometric identification values;
initiating a normal transaction if the received biometric information corresponds to the normal biometric identification value; and
initiating an emergency response to the duress transaction;
wherein the emergency response causes the communication device to contact an emergency operator.

27. A method for responding to a duress identification at a remote transaction terminal of an automated banking system having a biometric reader that includes a pressure-sensitive switch, a memory, a processor, and a cash dispenser, the method comprising:
storing at least one biometric identification value in the memory;
storing biometric information received at the biometric reader in the memory;
comparing the received biometric information with the at least one biometric identification value stored in the memory;
receiving an input from the pressure-sensitive switch; and
initiating an emergency response upon receiving the input from the pressure-sensitive switch if the received biometric information corresponds to the at least one biometric identification value stored in the memory.

28. The method of claim 27, further comprising the step of:
initiating a transaction to dispense cash if an emergency response is initiated.

29. The method of claim 28, wherein the transaction to dispense cash is carried out in a manner identical to a transaction to dispense cash made if no duress biometric information is received.

30. The method of claim 28, further comprising the step of,
causing a communication device to make a communication if an emergency response is initiated.

31. The method of claim 28, further comprising the step of:
delaying the transaction time of the remote terminal if an emergency response is initiated.

32. The method of claim 28, further comprising the step of:
limiting the cash available to be dispensed by the cash dispenser if an emergency response is initiated.

33. The method of claim 28, further comprising the step of:
recording events in proximity to the remote transaction terminal if an emergency response is initiated.
